(19) United States
(12) Patent Application Publication
(10) Pub. No.: US 2015/0086956 A1
(43) Pub. Date: Mar. 26, 2015

(54) SYSTEM AND METHOD FOR CO-REGISTRATION AND NAVIGATION OF THREE-DIMENSIONAL ULTRASOUND AND ALTERNATIVE RADIOGRAPHIC DATA SETS

(71) Applicants: Eric Savitsky, Malibu, CA (US); Gabriele Nataneli, Los Angeles, CA (US); Kresimir Petrinec, Los Angeles, CA (US)

(72) Inventors: Eric Savitsky, Malibu, CA (US); Gabriele Nataneli, Los Angeles, CA (US); Kresimir Petrinec, Los Angeles, CA (US)

(21) Appl. No.: 14/494,459

(22) Filed: Sep. 23, 2014

Related U.S. Application Data
(60) Provisional application No. 61/881,347, filed on Sep. 23, 2013.

(51) Int. Cl. G09B 23/28; G06T 19/00; G06T 7/00

(52) U.S. Cl. CPC G09B 23/286; G06T 7/0014; G06T 19/003; G06T 2207/10136; G06T 2207/20172; G06T 2219/004
USPC 434/267

(57) ABSTRACT

A co-registration and navigations system in which 3D and/or 2D ultrasound images are displayed alongside virtual images of a patient and/or CT or MRI scans, or other similar imaging techniques used in the medical field.

### CROSS-REFERENCES TO RELATED APPLICATIONS

This application claims the benefit of U.S. Provisional Patent Application Ser. No. 61/881,347 filed Sep. 23, 2013, which is incorporated herein by this reference thereto.

### BACKGROUND OF THE INVENTION

1. Field of the Invention

The present invention relates to a training technology for the mastery of basic skills in ultrasonography.

2. Description of the Related Art

Ultrasonography is a powerful imaging modality that is garnering growing importance in clinical medicine. Ultrasound imaging is free from harmful radiation, it works in real-time, it is portable, and substantially less expensive compared to other radiographic methods, such as X-ray, CT, and MRI scans. Nevertheless, ultrasound scans are difficult to interpret and medical professionals require extensive training to master the skills required to use them effectively as a diagnostic tool. The major challenges of ultrasonography are that:
Anatomical structures are often not demarcated distinctly by clear visual boundaries
Navigating ultrasound data requires specialized visuospacial and psychomotor skills
Certain anatomical structures may be concealed by shadowing effects and other artifacts specific to ultrasonography
The footprint of pre-recorded ultrasound scans is much smaller that CT and MRI, which are capable of covering a large section of an adult body

On the other hand, in spite of their limitations, other more traditional imaging modalities such as CT and MRI offer a much cleaner picture with fewer artifacts, thus making them substantially easier to interpret. Hinging on this fact, the present invention specifies a method to co-register and visually render ultrasound slices alongside CT and/or MRI data on a computer screen.

### SUMMARY OF THE INVENTION

The invention comprises a co-registration and navigation system in which 3D and/or 2D ultrasound images are displayed alongside virtual images of a patient and/or CT or MRI scans, or other similar imaging techniques used in the medical field.

### DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The following are a number of preferred embodiments of the system with the understanding that the present description is not intended as the sole form in which the invention may be constructed or utilized. Furthermore, it focuses on 3D data sets, even though the same approach may be applied for registering 2D data sets with 3D data sets, and 2D data sets with each other. Although also emphasizing CT and MRI as primary examples of imaging modalities that offer a higher degree of clarity compared to ultrasound, the same description applies to any other similarly capable technique such as Positron Emission Tomography (PET) or emerging medical technologies based on Terahertz imaging.

Co-Registration of Ultrasound Data with other Imaging Modality:

The problem of co-registering distinct modalities of medical data is very important, well-studied, and has many key applications both in the clinical setting and in research. However, most existing methods propose algorithms and techniques that are restricted to co-registration of CT and MRI and few solutions exist to co-register ultrasound data with other data sets. The problem is that, while CT and MRI scans possess clear boundaries between anatomical regions and distinct features that can be used as landmarks for alignment, such features are not commonly found in ultrasound. Ultrasound also suffers from other limitations such as:
Shadowing effects that restrict the visibility of certain structures
Anisotropy that results in structures looking differently when viewed at different angles.
Speckle noise

The quest for co-registering ultrasound with other modalities is further complicated by the fact that the shape and appearance of ultrasound alone is often not enough to disambiguate uniquely the nature of a structure, and practitioners need to rely on detailed medical knowledge of anatomy and the location of the transducer to formulate a correct interpretation of a medical scan. Unfortunately computers cannot yet exploit such high-level information to reason about medical images and identify automatically meaningful semantic similarities between ultrasound and other modalities. Although full automation is still elusive, the solution presented here can effectively aid medical experts to align data readily on a computer in an interactive manner.

The co-registration system allows the user to align medical data sets with a rendered 3D virtual body that provides a reasonably accurate representation of anatomy, and with each other. The user can view the medical data sets in a computer graphic 3D scene that includes the virtual body, either as a point cloud, a volume rendering, or other representation that clearly defines their position and orientation within the 3D space of the scene. The user can also use a motion controller or other computer peripheral to visualize slices that represent 2D sections of the 3D data sets. The slicing component relies on sampling the 3D data and mimics how practitioners review 3D ultrasound volumes, but it can be used without modification for any other 3D data set such as CT or MRI. The 2D slices are expected to emulate very closely the appearance of real medical scans as it has been already demonstrated in commercially available solutions for ultrasound training Thus, the user will be able to see simultaneously on the same screen:
The virtual body
A rendering of the spacial extent of 3D medical data at the correct scale (e.g., volume rendering)
Multiple 2D views of a slice of the 3D data
A quadrilateral representing the scanning plane used to sample the 3D data to obtain the 2D view

The advantage of this new system is that it allows trainees to easily recognize the appearance of anatomical structures in ultrasound slices by comparing a traditional ultrasound view to co-registered CT and/or MRI. This technology includes several components:
A method to co-register various imaging modalities with ultrasound data
A graphical user interface to visualize the ultrasound data alongside other imaging modalities
A method for navigating ultrasound data alongside co-registered CT and MRI

These elements should be arranged on screen neatly, and a good software implementation may allow the user to configure such arrangement in different ways to showcase each element distinctly and keep the view uncluttered.

Grab Feature:

The user selects a 3D data set of real anatomy and with a motion controller or other peripheral he/she can change its position and orientation on screen in order to place it correctly within the virtual body. The behavior is similar to grabbing the object in 3D space and moving it around. Real-time rendering of the 3D data provides valuable visual feedback to the user while the volume is being moved. When fanning through the 3D data set, the user can simultaneously see how the scanning plane intersects the rendered anatomy of the virtual body as well as a 2D slice that emulates very closely the familiar look of the same anatomy in real medical scans. These visual components inform the practitioner of the proper alignment of the 3D data with the virtual body. This feature of the system is particularly valuable for aligning 3D ultrasound data, which is hard to accomplish using other methods.

Position and Orientation of Ultrasound Transducer:

As mentioned before, the correct alignment of ultrasound data with the virtual body relies heavily on knowing the actual position of the ultrasound transducer with respect to the patient at the time of capture. This information can be obtained by recording a scene video with a video acquisition device that captures the location of the transducer while the scan is being performed. The scene video is typically sufficient to provide enough reference to a medical expert for the purpose of aligning ultrasound data with the virtual body.

Isosurfaces:

Unlike ultrasound, other image modalities such as CT or MRI display clear boundaries between anatomical structures and contiguous regions in the body tend to have a uniform appearance. For this reason, many techniques exist to segment CT and MRI volumes automatically or semi-automatically. The segmented regions can be shown on screen as explicit renderings of isosurfaces. As an example, simple thresholding of intensity values is often sufficient to generate usable isosurfaces. With the isosurface as a reference, the user can use a technique similar to the grab tool to align the entire 3D data set with the virtual body. If the alignment is correct, the rendering of the isosurface should overlap the rendered geometry of the virtual body.

Fine Tuning and Landmarks:

Once all the medical data sets have been aligned with the virtual body, users can proceed to fine tune the alignment of overlapping data sets. A useful tool for the alignment of disparate data sets is the use of landmarks. Landmarks are distinct features in the data set that relate to the underlying anatomy. The proposed system allows the user to identify and mark corresponding landmarks on two overlapping data sets he/she wishes to align. Then the user can either complete the alignment of the data sets by visually aligning the landmarks as closely as possible or the system can provide automatic methods of rigid-body registration such as Iterative Closest Point (ICP) or other well-known techniques for aligning point clouds.

Split Screen Comparison:

During fine tuning, the system allows the user to view 2D slices of the 3D data sets side-by-side. This way he/she can visually compare the two views while performing the alignment to ensure that the two views showcase the same anatomy in the same position. This kind of visual feedback is especially important when we consider that distinct medical data sets may never align perfectly with each other.

Discrepancies:

Even when a CT, an MRI, and an ultrasound scan come from the same patient, the same anatomical regions may not overlap well in each data set. The problem is that internal anatomy changes very easily in response to a multitude of factors including:
The pose of the patient during the scan.
The amount of food and liquid in the body.
Blood pressure.
The natural pressure that the sonographer applies to the body when pressing on the body with the ultrasound transducer.

Such natural discrepancies make it particularly hard to align anatomical features across multiple heterogeneous data sets and only the judgment of a medical expert can establish whether the co-registration is satisfactory or not. Thus, the tools outlined in the present invention are highly useful for this purpose as they give users a great deal of control over the process and provide constant visual feedback. In addition, if users of the system have control over the acquisition process, the may alleviate discrepancies by ensuring that the conditions under which the patient is scanned with different modalities are as consistent as possible.

Graphical-User-Interface and User Interactions:

In this section we describe a preferred embodiment where the co-registered data sets are presented to the user in the context of an ultrasound training simulator. The Graphical User Interface (GUI) must display the following items:
A 3D rendering of the virtual body
A 3D rendering of a virtual probe that clearly defines the position and orientation of the ultrasound transducer with respect to the virtual body
A slice panel, that shows two or more 2D sections of the medical data sets
A set of buttons and other user interface (UI) elements to control the workflow of the application (e.g., select a medical case to review and other options pertaining to the visualization)

The position and orientation of the virtual body and all the co-registered data sets must be expressed consistently with respect to a global reference frame and stored on disk. The virtual body and the probe are always visible on screen in a main 3D rendered view. The user manipulates a motion controller or other peripheral to vary the position and/or orientation of the virtual probe with respect to the virtual body. Based on the 3D relative position of the virtual probe and the body, the software computes the correct section of the medical data sets that are registered to that location in 3D space. The slice panel shows the 2D slice corresponding to each data set side-by-side either in a horizontal or vertical arrangement. This way, as the user navigates ultrasound data, he will also see the co-registered slices computed from other modalities, such as CT and MRI.

Enhancements:

A principal purpose of this invention is to construct a tool that supports the understanding of ultrasound data with additional co-registered medical data sets. Since, as discussed earlier, the correspondence between anatomical features may not always be exact between different data sets, it is highly useful to enhance the corresponding views with colors and labels that highlight corresponding regions in each scan.

While the present invention has been described with regards to particular embodiments, it is recognized that additional variations of the present invention may be devised without departing from the inventive concept.

What is claimed is:

1. A method for co-registration and navigation of three-dimensional ultrasound and alternative radiographic data sets comprising
displaying a virtual body,
selecting a 3D data set of real anatomy,
displaying a rendering of the spacial extent of the 3D data set in real-time,
aligning the rendering within the virtual body,
displaying a quadrilateral representing a scanning plane used to sample the 3D data to obtain the 2D view,
computing the 2D section of the medical data sets that are registered to the given location in 3D space based on the 3D relative position of the virtual probe and the body using thresholding of intensity values to generate usable isosurfaces,
displaying at least one 2D view of a slice of the 3D data,
displaying the 2D slice on the slice pane side-by-side at least one corresponding data set computed from a corresponding CT or MRI,
navigating ultrasound data alongside corresponding CT and MRI image,
changing the position and orientation of the rendering of the 3D data set on screen by
varying the position and/or orientation of the virtual probe with respect to the virtual body in accordance with a motion controller, and
enhancing the corresponding views with colors and labels that highlight corresponding regions in each scan.

2. A method for co-registration and navigation of three-dimensional ultrasound and alternative radiographic data sets comprising
displaying a virtual body,
selecting a 3D data set of real anatomy,
displaying a rendering of the spacial extent of the 3D data set,
aligning the rendering within the virtual body,
computing the 2D section of the medical data sets based on the 3D relative position of the virtual probe and the body,
displaying at least one 2D view of a slice of the 3D data, and
changing the position and orientation of the rendering of the 3D data set on screen by varying the position and/or orientation of the virtual probe with respect to the virtual body in accordance with a motion controller.

3. The method of claim 2, wherein the spacial element of the 3D data set is rendered in real-time.

4. The method of claim 2, further comprising displaying a quadrilateral representing a scanning plane used to sample the 3D data to obtain the 2D view.

5. The method of claim 2, wherein the medical data sets are registered to the given location in 3D space.

6. The method of claim 2, wherein the medical data sets use thresholding of intensity values to generate usable isosurfaces.

7. The method of claim 2, further comprising displaying the 2D slice on the slice pane side-by-side at least one corresponding data set computed from a corresponding CT or MRI.

8. The method of claim 2, further comprising navigating ultrasound data alongside corresponding CT and MRI image.

9. The method of claim 2, further comprising enhancing the corresponding views with colors and labels that highlight corresponding regions in each scan.

10. A system for displaying the co-registered data sets of an ultrasound training simulator, comprising:
a 3D rendering of the virtual body
a 3D rendering of a virtual probe that clearly defines the position and orientation of the ultrasound transducer with respect to the virtual body
a computer configured to display a 3D data set and slices that represent 2D slices of the 3D data set, as well as other 3D data sets from corresponding CT or MRI scans, and to simultaneously display a virtual body,
a slice panel that shows two or more 2D sections of the medical data sets, and
a motion controller for moving the transducer.

11. The system of claim 10 further comprising a set of buttons and other graphical user interface elements to control the workflow of the application.

12. A diagnostic tool for supporting the understanding of ultrasound data with additional co-registered medical data sets comprising
a 3D rendering of the virtual body
a 3D rendering of a virtual probe that clearly defines the position and orientation of the ultrasound transducer with respect to the virtual body
a computer configured to display a 3D data set and slices that represent 2D slices of the 3D data set, as well as other 3D data sets from corresponding CT or MRI scans, and to simultaneously display a virtual body,
a slice panel that shows two or more 2D sections of the medical data sets, and
a motion controller for moving the transducer.

13. The system of claim 12 further comprising a set of buttons and other user interface elements to control the workflow of the application.
